(19) United States
(12) Patent Application Publication
(10) Pub. No.: US 2008/0276771 A1
(43) Pub. Date: Nov. 13, 2008

(54) Method For Hardening A Machined Article

(75) Inventors: Ranajit Ghosh, Macungie, PA (US); Daniel James Gibson, Pen Argyl, PA (US)

Correspondence Address: AIR PRODUCTS AND CHEMICALS, INC.;PATENT DEPARTMENT, 7201 HAMILTON BOULEVARD, ALLENTOWN, PA, 181951501, US

(73) Assignee: Air Products and Chemicals, Inc., Allentown, PA (US)

(21) Appl. No.: 12/112,367

(22) Filed: Apr. 30, 2008

Related U.S. Application Data
(60) Provisional application No. 60/916,369, filed on May 7, 2007.

(51) Int. Cl. B23B 1/00; F25D 25/00

(52) U.S. Cl. 82/1.11; 62/62

(57) ABSTRACT

A machining method and an article manufactured therefrom, the method improving mechanical properties in a work surface by performing a very shallow machining pass using a cutting tool, in combination with application of a cryogenic fluid to the work surface and the cutting tool, the combination compressive force and cryogenic cooling increasing hardness, increasing compressive residual stress, and reducing surface roughness in the manufactured article.

### CROSS REFERENCE TO RELATED APPLICATION(S)

This application claims the benefit of U.S. Provisional Application No. 60/916,369 filed on May 7, 2007, which is incorporated by reference as if fully set forth. U.S. Published Application No. US 2005/211029 A1, filed on Mar. 25, 2004, is hereby incorporated by reference as if fully set forth.

### BACKGROUND

The present invention is directed to the field of forming and shaping materials by various processes known broadly as machining operations and in particular, it is directed to increasing subsurface hardness, increasing compressive residual stress, and reducing surface roughness in metals and other materials formed and shaped in a machining process that utilizes a spring pass in combination with cryogenic cooling to provide the above improved mechanical properties in the finished machined article.

Hardness and compressive residual stresses are two important criteria in material applications where a high demand is placed on wear and fatigue performance in the finished product. High surface and subsurface hardness improves product wear, while larger compressive residual stress improves resistance to fatigue failure, both improved properties extending the service life of finished articles. In the past, pre-machining and post-machining techniques, for example shot peening, laser peening, and roller burnishing were used to improve both hardness and compressive residual stress. In addition, a combination of pressure and speed is used in burnishing operations to work harden material by stretching and hardening the surface with minimal or no material loss. However, such processes have limited application and include inherent problems. Peening and burnishing can only be applied to certain geometries and they are normally limited to external surfaces, e.g. an outside diameter or a flat surface. In addition, peening and burnishing techniques need dedicated machines that require special setup time and increase manufacturing costs.

The application of a cryogenic coolant to a work surface has been shown to improve surface hardness during forming or shaping operations. This technique appears, however, to result in only limited improvement in subsurface hardness.

Related prior art includes U.S. Published Application No. 2005/211029, filed on Mar. 25, 2005.

### SUMMARY OF THE INVENTION

In one respect, the invention comprises a method of machining a work surface. A first machining pass is performed on the work surface using a first cutting tool positioned at a skim depth that is no greater than −254 μm. The work surface is cooled with a cryogenic fluid while the first machining pass is being performed.

In another respect, the invention comprises an article machined by the method described in the preceding paragraph and being characterized by at least one from the group of: reduced surface roughness, increased surface hardness, increased subsurface hardness to a depth of 150 μm, and reduced surface roughness than would be obtained if the first machining step had not been performed.

In yet another respect, the invention comprises a method of machining a work surface. A first machining pass is performed on the work surface using a first cutting tool positioned at a skim depth that is no greater than −12.7 μm. The work surface is cooled with a cryogenic fluid for a predetermined period of time immediately prior to performing the first machining pass. In addition, the first cutting tool and the work surface are cooled with the cryogenic fluid while the first machining pass is being performed.

### BRIEF DESCRIPTION OF THE DRAWINGS

The following detailed description of the preferred embodiments of the invention will be better understood when read in conjunction with the appended drawings. For purposes of illustrating the invention, drawings depict the embodiments which are presently preferred. It is understood, however, that the invention is not limited to the precise arrangements and instrumentality shown in the drawings:

FIG. 1 is an isometric view showing exemplary machining apparatus adapted for use with the present invention;

FIG. 2 is a cross-section view through the exemplary machining apparatus in FIG. 5;

FIG. 3 is a schematic view showing a machining tool applying a compressive force to a workpiece;

FIG. 4 is a schematic view showing a machining tool applying a compressive force to a workpiece at a shallower tool depth than shown in FIG. 3;

FIG. 5 is a graph showing hardness data for a first set of comparative tests performed on a machined article; and

FIG. 6 is a graph showing hardness data for a second set of comparative tests performed on a machined article.

### DETAILED DESCRIPTION OF THE INVENTION

The present invention includes a machining method for improving mechanical properties in materials by increasing subsurface hardness, increasing compressive residual stress, and reducing surface roughness in a machined workpiece or article manufactured by the method. Although this invention is discussed herein in the context of machining a workpiece with a cutting tool, persons skilled in the art will recognize that the invention includes broader applications and may be used in different shaping and forming processes, including but not limited to other types of machining, rolling, bending, stamping, profiling, drawing, etc.

The present invention is a method of machining a workpiece using a compressive force in combination with a cryogenic fluid sprayed or jetted onto either the machining tool or a portion of the work surface, or onto both the machining tool and the work surface. The combination of the compressive force and simultaneous cryogenic cooling, hereinafter referred to as a spring pass, increases hardness, increases compressive residual stress, and reduces surface roughness in the workpiece. The improved properties provided by the spring pass increase wear resistance and fatigue performance, and improve surface appearance in the machined workpiece.

As used herein, the terms “machining,” “machine pass,” or “machining pass” includes but is not limited to forming or shaping operations that include turning, boring, parting, grooving, facing, planning, milling, drilling, and other operations that generate continuous chips or fragmented or segmented chips.

As used herein, the term “cutting tool” refers to a tool insert that remains in a fixed position relative to the tool holder as a machining pass is performed with the cutting tool. Tools having work piece-engaging surfaces that pivot or rotate, such as conventional burnishing tools, are not considered “cutting tools” for the purposes of this application.

As used herein, the term “skim depth” should be understood to mean machining tool insert depth setting. In this application, skim depth measurements are expressed as negative numbers and are measured from the outermost portion of the workpiece surface. For instance, a skim depth of −254 μm for a tool insert means that the insert is positioned 254 μm below the outermost portion of the workpiece surface. For the purposes of this application, the statement that a skim depth that is “no less than” a particular value should be understood to mean that the skim depth is no shallower than the value specified. Conversely, the statement that a skim depth that is “no greater than” a particular value should be understood to mean that the skim depth is no deeper than the value specified. For example, a skim depth of −254 μm would be considered greater than a skim depth of −127 μm.

As used herein, the term “jetting,” when used in the context of a cryogenic fluid, should be construed broadly to include any known means of discharging a cryogenic fluid onto a surface (in liquid, vapor and/or mixed liquid-vapor phase).

The term “cryogenic cooling,” “cryogenic coolant,” or “cryogenic fluid” includes any fluid with a boiling point lower than −70° C. This can include, but is not limited to liquefied gases of nitrogen (LIN), argon (LAR), helium (LHe) and carbon dioxide (LCO2).

The invention comprises performing a very shallow machining pass (referred to herein as a “spring pass”) on a workpiece while, at the same time, applying a cryogen (e.g., LIN) to the tool insert and the workpiece (hereinafter referred to as a “cryogenic spring pass”). Preferably, the cryogen is applied in the manner described in U.S. Published Application No. 2005/211029, filed on Mar. 25, 2005 (referred to herein as the “Zurecki process”). In addition, it is preferable that the cryogen be directed toward the area of the workpiece that is in contact with the tool insert (hereinafter “tool contact area”), the area just upstream from the tool contact area, and the area just downstream from the contact area. In addition, the spring pass is preferably performed on the workpiece after a finishing pass is performed, so that the workpiece surface is already relatively smooth. A typical finishing pass has at a skim depth of −0.005 to −0.015 inches (−127 to −381 μm), while a spring pass is typically performed at a significantly shallower skim depth.

As will be described in greater detail herein, performing a cryogenic spring pass after a finishing pass reduces workpiece surface roughness and increases both surface and subsurface hardness. In addition, cold working of the surface increases compressive residual stress in the workpiece, which produces improved wear and fatigue performance in the finished article.

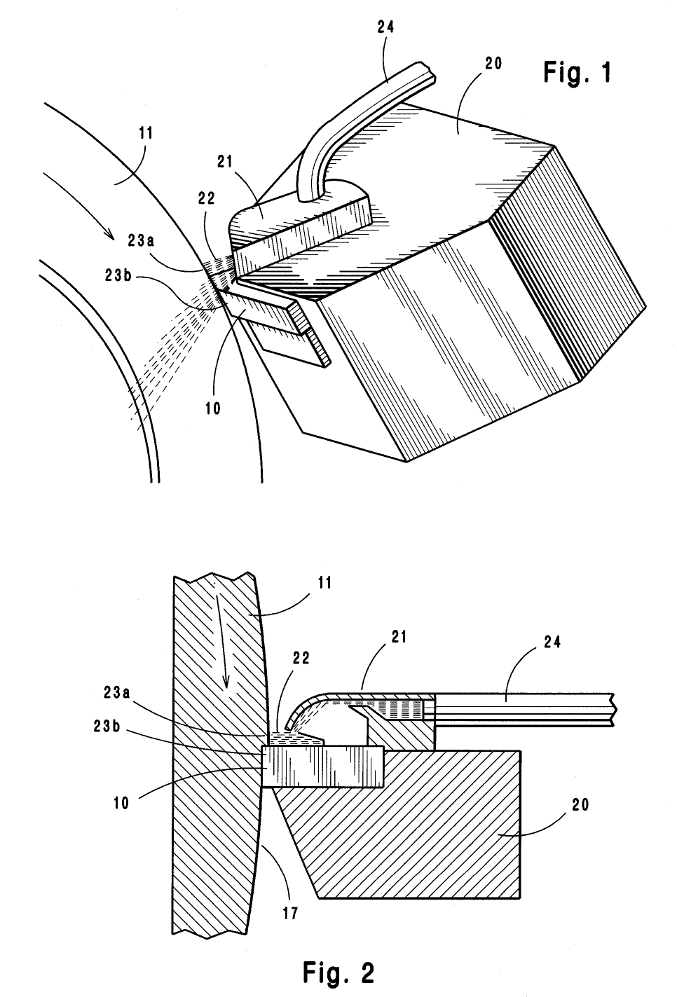

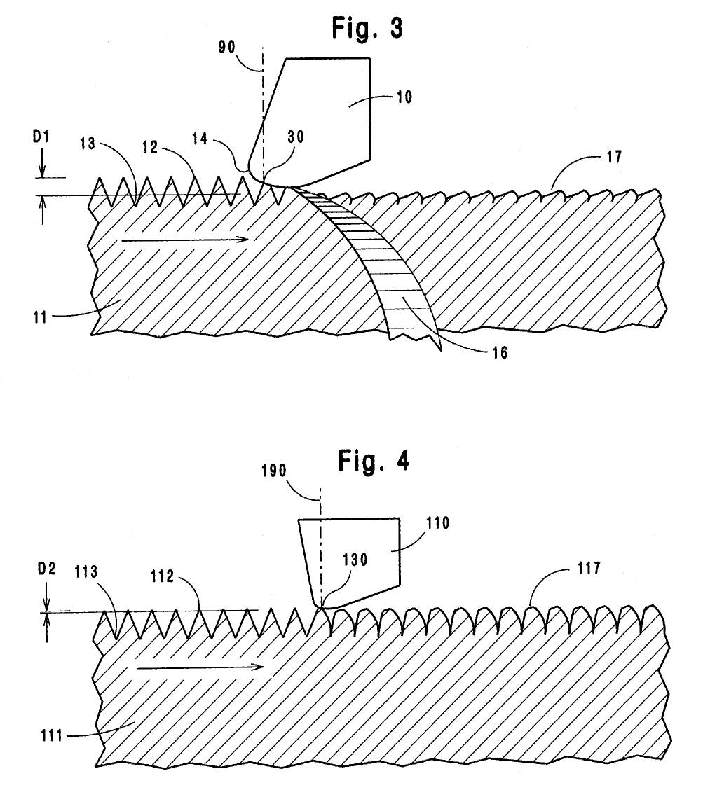

Referring to FIGS. 1 and 2, an exemplary machining apparatus for implementing the present invention is shown. The apparatus includes a work piece 11 supported in a lathe (not shown). A turning tool 10 (also referred to as a tool insert or a cutting insert), removably fixed within a tool holder 20 is set at a desired skim depth (see D1 and D2, FIGS. 3 and 4, respectively). Tool holder 20 is adjusted to provide a machining pass as the workpiece 11 moves in the direction indicated by the arrows shown in FIGS. 1 and 2. The tool holder 20 is part of a tool turret (not shown), which typically includes more than one tool holder.

A cryogenic spray apparatus that includes a nozzle 21 is positioned to deliver a jet or spray of cryogenic fluid 22 onto the turning tool 10, onto the portion 23a of the surface the workpiece immediately upstream from the tool insert 10, and onto the portion 23b of the surface of the workpiece 11 immediately downstream from the tool insert 10. The apparatus also includes a nozzle 21 which receives an incoming flow of a cryogen (preferably a liquid cryogen, such as LIN) from feed line 24. The nozzle 21 is preferably either attached to, or synchronized with the travel of, tool holder 20, so that a continuous stream of the cryogen is directed onto the turning tool 10 and portions 23a, 23b of the workpiece 11 during a machining pass.

In addition, it is preferable to move the tool holder into position for a machining pass and begin jetting the cryogenic fluid onto the workpiece for a predetermined period of time (e.g., five seconds) immediately prior to beginning a cryogenic spring pass. This “pre-cooling” step reduces the temperature of the entire workpiece (as well as the cutting tool), which results in increased hardness and increased compressive residual stress in the finished product that if the “pre-cooling” is not performed.

FIGS. 3 and 4 show schematic representations of examples of two different spring pass configurations. In both FIGS. 3 and 4, the direction of movement of the workpiece 11, 111 with respect to the tool insert 10,100 (respectively) is in the direction indicated by the arrow included in each of these figures. In order to simplify FIGS. 3 and 4, only the workpieces 11, 111 and tool inserts 10, 110 are shown. All other features are omitted. In addition, peaks and valleys 12, 112 and 13, 113 on the surface of the workpieces 11, 111 (respectively), and the geometries of the tool inserts 10, 110 are exaggerated in FIGS. 3 and 4 in order to aid in visualization.

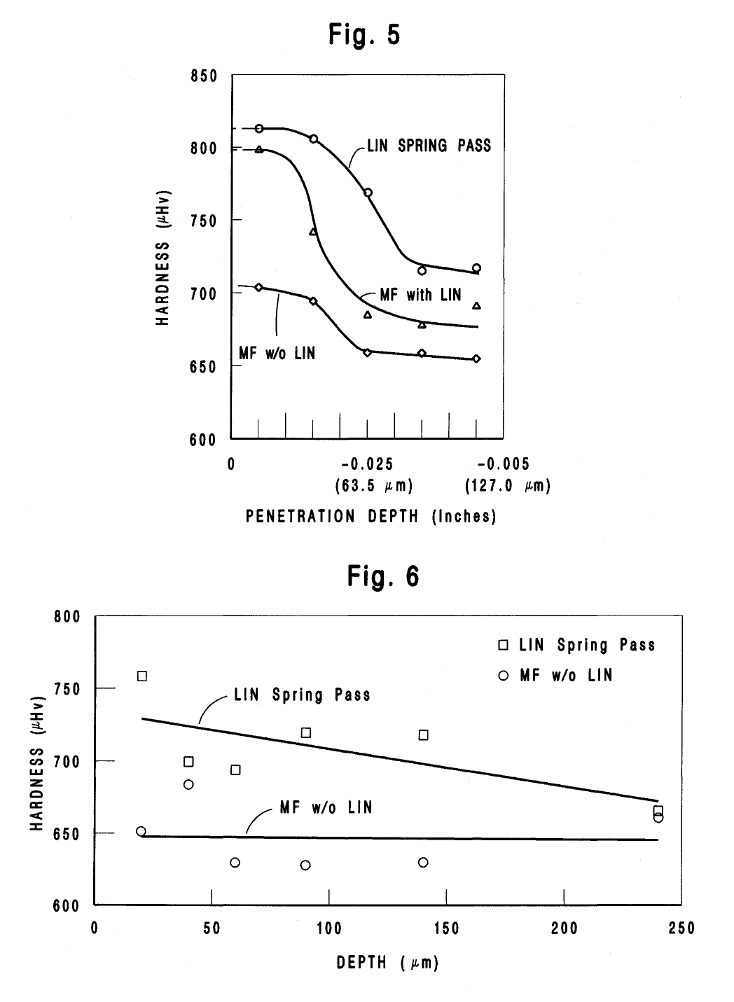

In FIG. 3, tool insert 10 is set at a relatively deep skim depth D1 for the spring pass, about −0.005 inches (−127 μm) with respect to the workpiece surface. As shown in the drawing, the skim depth setting D1 of the tool 10 is measured from a workpiece surface that has surface roughness defined by exaggerated peaks and valleys 12 and 13 respectively. A stream of LIN (FIGS. 5 and 6) in the form of gas (vapor) or liquid or a mixture of gas and liquid is sprayed or jetted onto tool 10 and the adjacent work surface to provide cryogenic cooling. In this embodiment, the tool insert 10 has a positive rake angle (relative to line 90, which is perpendicular to the workpiece surface 17), a relatively large edge radius 30 and relatively large nose radius (not shown). As the tool insert 10 passes over the workpiece 11, the workpiece material located in the peaks 12 on the surface 17 of the workpiece 11 (resulting from the finishing pass) are compressed downwardly and laterally into the valleys 13. In this embodiment, a small chip 16 is produced by the spring pass, due primarily to the relatively deep skim depth D1 and the use of a positive rake angle.

A different tool insert setup and skim depth are shown in FIG. 4. In FIG. 4, the skim depth D2 of about −0.0005 inches (−12.7 μm) or less relative to the surface 117 of the workpiece 111 is used. In addition, the tool insert 110 is set at a negative rake angle (relative to line 190, which is perpendicular to the workpiece surface 117) and has smaller edge radius 130 and nose radius (not shown) than the tool insert 10 shown in FIG. 4.

As explained above, one of the purposes of the cryogenic spring pass is to smoothen and harden the surface of the workpiece by compressing the workpiece surface peaks and “pushing” them into the valleys. Although it is acceptable for small amount of workpiece cut away during a spring pass, it is preferable that cutting of the workpiece material be minimized. Although acceptable skim depths for the cryogenic spring pass could be in the range of −0.0001 to −0.010 inches (−2.5 to −254 μm), the preferred range is being between −0.0003 to −0.005 inches (−7.62 to −127 μm) and, more preferably, between −0.0003 and −0.0005 inches (−7.62 to −12.7 μm).

Cutting and tooling variables like skim depth, tool rake angle, nose and edge radii need to be selected appropriately to produce the most desirable effect on surface finish, surface and subsurface hardness and compressive residual stresses. The depth of cut to edge radius ratio can be used as a rough guide for selecting appropriate tool geometry and cutting parameters. A ratio of 0.5 to 25 is an acceptable range, while a ratio of 3 to 10 is preferred.

Because the cryogenic spring pass can be performed using a cutting tool (which can use the same type of tool holder as conventional machining passes), the spring pass can be performed using the same machine tool (tool turret) as other machining passes on the workpiece, including the finishing pass. This results in reduced machining time and cost, as compared to existing hardening techniques, such as shot peening, laser peening, and roller burnishing.

Comparative tests conducted on machined materials using a present invention indicated that performing a cryogenic spring pass after a finishing pass (with or without a cryogen) reduces workpiece surface roughness and increases both surface and subsurface hardness. FIG. 5 is a graph showing micro-hardness values (Vickers scale), plotted for three different final machining passes. For all three tests, the workpiece was stainless steel. A 0.5 inch (1.27 centimeter) round cubic boron nitride (CBN) insert was used at a rake angle of approximately −20 degrees for roughing, finishing and spring passes.

In the first test sample, the final machining step was a conventional or “dry” finish pass (the line labeled “MF w/o LIN” in FIG. 5), surface hardness of about 707 μHv was measured. Subsurface hardness ranged between about 704 μHv at a depth of about −0.0005 inches (−12.7 μm) and about 654 μHv at a depth of about −0.0045 inches (−114.3 μm).

In the second test sample, the final machining step was a finish pass in which a LIN was sprayed onto the tool insert and adjacent workpiece surfaces in accordance with the above-mentioned Zurecki process (labeled “MF with LIN” in FIG. 5). As expected, the use of LIN during the finish pass improved surface hardness to about 808 μHv. However, the addition of LIN to the finish pass resulted in a very small increase in subsurface hardness improvement, and therefore, little improvement in the compressive residual stress that enhances fatigue performance. Subsurface hardness for the LIN Finish Pass ranges between about 808 μHv at a depth of −12.7 μm to about 677 μHv at a depth of −114.3 μm.

In the third test sample, the final machining step was a cryogenic spring pass (labeled “LIN Spring Pass” in FIG. 5) performed at a skim depth of −0.0003 inches. The cutting tool used was the same as the finish pass tool, but the part was cooled with the cryogenic jet for approximately five seconds just prior to commencing the spring pass. The results of this test showed a surface hardness of about 813 μHv (which was similar to the results obtained from the finish pass with LIN). There was, however, a significant improvement in subsurface hardness achieved using the cryogenic spring pass (as compared to results achieved with either the dry or LIN finish passes). For example, at a depth of −0.0015 inches (−38.1 μm), the cryogenic spring pass provides a subsurface hardness of about 806 μHv, compared with 741 μHv for the LIN finish pass (an improvement of about 8.8%). At a depth of −0.0025 inches (−63.5 μm), the cryogenic spring pass provides a subsurface hardness of 769 μHv, compared to 684 μHv for the LIN finish pass (an improvement of 12.4%). Based on these tests, a cryogenic spring pass provides increased subsurface hardness to a depth of at least 150 μm.

In addition to providing the above-described improved hardness and compressive stress properties, use of a cryogenic spring pass as the final machining step reduces surface roughness. Referring to Table 1 shown below, use of the cryogenic spring pass results in reduced surface roughness, as compared to a workpiece on which a dry or LIN finish pass was the final machining step. The roughness of test sample was measured using four different probe angles, from which an average was calculated. Average surface roughness for the “LIN spring pass” sample was 4.3 micro-inches, demonstrating a 41% improvement over “MF with LIN” and a 75% improvement over “MF w/o LIN” samples.

TABLE 1
Surface Roughness

| Sample | 0 deg. | 90 deg. | 180 deg. | 270 deg. | Average |
|---|---|---|---|---|---|
| DRY (conventional) | 14 | 18 | 19 | 16 | 16.8 |
| LIN (top cooling | 6 | 8 | 9 | 6 | 7.3 |
| only) | | | | | |
| LIN (spring pass) | 4 | 4 | 4 | 5 | 4.3 |

Results of additional comparative subsurface hardness tests are shown in FIG. 6. In these tests, the workpiece was Triballoy T400, all other tooling parameters were the same as for the tests described above. As with the tests described above and shown in FIG. 5, the portion of the workpiece on which a cryogenic spring pass was performed after a finishing pass exhibited significantly higher subsurface hardness than portions of the workpiece on which a LIN finishing pass was performed.

It is recognized by those skilled in the art that changes may be made to the above-described embodiments of the invention without departing from the broad inventive concepts thereof. It is understood, therefore, that this invention is not limited to the particular embodiments disclosed.

1. A method of machining a work surface, the method comprising:
performing a first machining pass on at least a portion of the work surface using a first cutting tool positioned at a skim depth that is no greater than −254 μm; and
cooling the at least a portion of the work surface with a cryogenic fluid while the first machining pass is being performed.

2. The method in claim 1, further comprising:
prior to performing the first machining pass, performing a second machining pass on the at least a portion of the work surface using a second cutting tool positioned at a skim depth that is greater than −254 μm.

3. The method of claim 2, wherein performing the second machining pass comprises performing the second machining pass on the at least a portion of the work surface using the second cutting tool positioned at a skim depth that is no less than −381 μm.

4. The method of claim 1, wherein performing the first machining pass comprises performing the first machining pass on the at least a portion of the work surface using the first cutting tool at a skim depth that is no greater than −127 μm.

5. The method of claim 1, wherein performing the first machining pass comprises performing the first machining pass on the at least a portion of the work surface using the first cutting tool at a skim depth that is no greater than −12.7 μm.

6. The method of claim 1, further comprising:
cooling the at least a portion of the work surface with the cryogenic fluid for a predetermined period of time immediately prior to performing the first machining pass.

7. The method of claim 1, further comprising:
cooling the first cutting tool with the cryogenic fluid while the first machining pass is being performed.

8. The method of claim 1, further comprising:
cooling the second cuffing tool with the cryogenic fluid while the second machining pass is being performed.

9. The method of claim 1, further comprising:
retaining the first cutting tool in a first tool holder during the first machining pass, the first tool holder being attached to a first tool turret; and
retaining the second cutting tool in a second tool holder during the second machining pass, the second tool holder being attached to the first tool turret.

10. The method of claim 1, wherein the first machining pass is performed using a first cutting tool having a nose radius that is no less than 0.038 centimeters.

11. The method of claim 1, wherein the first machining pass is performed using a first cutting tool having an edge radius that is no less than 2.5 micrometers.

12. The method of claim 1, wherein the first cutting tool has an edge radius and the skim depth at which the first machining pass is performed is between 0.5 and 25 times the edge radius.

13. The method of claim 1, wherein the first cutting tool has an edge radius and the skim depth at which the first machining pass is performed is between 3 and 10 times the edge radius.

14. The method of claim 1, wherein the first machining pass is performed with the first cutting tool at a negative rake angle.

15. The method of claim 1, wherein the cooling step further comprises jetting the cryogenic fluid onto the first cutting tool and the at least a portion of the work surface during the first machining pass using a nozzle affixed to a first tool holder, the first tool holder also retaining the first cutting tool during the first machining pass.

16. The method of claim 1, further comprising, performing the first machining pass without generating any chips from the at least a portion of the work surface.

17. An article machined by the method of claim 1, and being characterized by at least one from the group of: reduced surface roughness, increased surface hardness, increased subsurface hardness to a depth of 150 μm, and reduced surface roughness than would be obtained if the first machining step had not been performed.

18. A method of machining a work surface, the method comprising:
performing a first machining pass on at least a portion of the work surface using a first cutting tool positioned at a skim depth that is no greater than −12.7 μm;
cooling the work surface with a cryogenic fluid for a predetermined period of time immediately prior to performing the first machining pass;
cooling the first cutting tool and the at least a portion of the work surface with the cryogenic fluid while the first machining pass is being performed.
